(19) United States
(12) Patent Application Publication
(10) Pub. No.: US 2018/0213460 A1
(43) Pub. Date: Jul. 26, 2018

(54) NETWORKING DEVICES AND METHODS

(71) Applicant: QUALCOMM Incorporated, San Diego, CA (US)

(72) Inventors: Vinay ADELLA, Bangalore (IN); Anirban SIRKHELL, Bangalore (IN); Balaganapathy PALANISAMI, Erode (IN); Jeevan KUKKALLI, Bangalore (IN)

(21) Appl. No.: 15/835,036

(22) Filed: Dec. 7, 2017

Related U.S. Application Data
(60) Provisional application No. 62/448,550, filed on Jan. 20, 2017.

(51) Int. Cl. H04W 40/02; H04W 40/28; H04L 12/721; H04W 28/02; H04W 40/24; H04W 40/34

(52) U.S. Cl. CPC H04W 40/02; H04W 40/28; H04W 40/34; H04W 28/0231; H04W 40/246; H04L 45/123

(57) ABSTRACT

A networking apparatus includes a communication circuitry configured to receive, via first control message data units (CMDUs), network information descriptive of links between network devices of a network. The networking apparatus also includes a processor configured to determine, based on the network information, an end-to-end routing path for unicast communications from the communication circuitry to a second network device of the network, where the end-to-end routing path traverses a first network device of the network. The processor is further configured to cause the communication circuitry to send, to the first network device via one or more second CMDUs, routing path information descriptive of at least a portion of the end-to-end routing path. The routing path information is configured to cause the first network device to forward, along the portion of the end-to-end routing path, unicast packets received from the communication circuitry and addressed to the second network device.

### I. CROSS REFERENCE TO RELATED APPLICATIONS

The present application claims priority from U.S. Provisional Patent Application No. 62/448,550 entitled “NETWORKING DEVICES AND METHODS,” filed Jan. 20, 2017, which is incorporated herein by reference in its entirety.

### II. FIELD

The present disclosure generally relates to networking devices and methods of communicating via a network.

### III. DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and Internet protocol (IP) telephones, can communicate voice and packets over wireless networks. Further, many such wireless telephones include other types of devices that are incorporated therein. For example, a wireless telephone can also include a digital still camera, a digital video camera, a digital recorder, and an audio file player. Also, such wireless telephones can process executable instructions, including software applications, such as a web browser application, that can be used to access the Internet. As such, these wireless telephones can include significant computing capabilities.

Many of these computing device are capable of communicating with other computing devices via a network. Various communication protocol standards are in place to facilitate communications among computing devices coupled to a network. For example, the Institute of Electrical and Electronics Engineers (IEEE) has promulgated standards to facilitate wireless networking, such as the various 802.11 standards. Other communication protocol standards are in place to simplify setting up a network, such as the IEEE 1905.1 standard to simply home networking. Nevertheless, it can be challenging to configure a network since many different computing devices may be involved, and the best configuration of the network may depend on the type of each computing device, resources available from each computing device, and resources required by each computing device. These challenges may be exacerbated when some or all of the computing devices are portable devices that occasionally join or leave the network, resulting in changes to the network configuration.

### IV. SUMMARY

According to one implementation of the present disclosure, a networking apparatus includes a communication circuitry configured to receive, via first control message data units (CMDUs), network information descriptive of links between network devices of a network. The networking apparatus also includes a processor configured to determine, based on the network information, an end-to-end routing path for unicast communications from the communication circuitry to a second network device of the network, where the end-to-end routing path traverses a first network device of the network. The processor is further configured to cause the communication circuitry to send, to the first network device via one or more second CMDUs, routing path information descriptive of at least a portion of the end-to-end routing path. The routing path information is configured to cause the first network device to forward, along the portion of the end-to-end routing path, unicast packets received from the communication circuitry and addressed to the second network device.

According to another implementation of the present disclosure, a method of communicating via a network includes receiving, at a first network device from one or more other network devices, first control message data units (CMDUs) including network information descriptive of links between network devices of a network. The method also includes determining, based on the network information, an end-to-end routing path for unicast communications from the first network device to a third network device of the network, where the end-to-end routing path traverses a second network device of the network. The method further includes sending, from the first network device to the second network device, one or more second CMDUs including routing path information descriptive of at least a portion of the end-to-end routing path. The routing path information is configured to cause the second network device to forward, along the portion of the end-to-end routing path, unicast packets received from the first network device and addressed to the third network device.

According to another implementation of the present disclosure, a networking apparatus includes means for receiving, at a first network device from one or more other network devices, first control message data units (CMDUs) including network information descriptive of links between network devices of a network. The networking apparatus also includes means for determining, based on the network information, an end-to-end routing path for unicast communications from the first network device to a third network device of the network, where the end-to-end routing path traverses a second network device of the network. The networking apparatus further includes means for sending, from the first network device to the second network device, one or more second CMDUs including routing path information descriptive of at least a portion of the end-to-end routing path. The routing path information is configured to cause the second network device to forward, along the portion of the end-to-end routing path, unicast packets received from the first network device and addressed to the third network device.

According to another implementation of the present disclosure, a non-transitory computer-readable medium storing instructions executable by a processor to cause the processor to perform operations. The operations include obtaining network information descriptive of links between network devices of a network. The operations also include determining, based on the network information, an end-to-end routing path for unicast communications from the first network device to a third network device of the network, where the end-to-end routing path traverses a second network device of the network. The operations further include causing a communication circuitry to send one or more control message data units (CMDUs) including routing path information descriptive of at least a portion of the end-to-end routing path. The routing path information is configured to cause the second network device to forward, along the portion of the end-to-end routing path, unicast packets received from the communication circuitry and addressed to the third network device.

### V. BRIEF DESCRIPTION OF THE DRAWINGS

FIG. 1 is a diagram illustrating a system including multiple network devices coupled via a network;

FIG. 2 is a diagram illustrating further aspects of the network of FIG. 1;

FIG. 3 is a diagram illustrating further aspects of the network of FIG. 1;

FIG. 4 is a diagram illustrating routing data of a particular network device of the network of FIG. 1;

FIG. 5 is a flow chart of an example of a method used by a network device of the network of FIG. 1;

FIG. 6 is a flow chart of an example of details of the method illustrated in FIG. 5;

FIG. 7 is a flow chart of another example of a method used by a network device of the network of FIG. 1;

FIG. 8 is flow chart of an example of a method used by a network device of the network of FIG. 1 to generate and send unicast data;

FIG. 9 is a flow chart of an example of a method used by a network device of the network of FIG. 1 to route unicast data; and

FIG. 10 is a flow chart of an example of a method used by a network device of the network of FIG. 1 to route non-unicast data.

### VI. DETAILED DESCRIPTION

Wireless networks that operate according to a IEEE 802.11 standard generally include one or more devices that act as stations and one or more devices that act as access points. Such wireless networks often have a star or daisy chain network topology. In both a star and a daisy chain topology, all communication within the network (e.g., from station to station within the network) is either directed toward an access point or directed from the access point. For example, in a star topology, the access point is a hub to route all communications. Thus, when an originating device of the network sends data to a destination device in the network, the data is directed from the originating device to the access point, and routed by the access point to the destination device. A daisy chain topology is similar except that the data may pass through one or more station devices on its way to the access point from the originating device or on its way from the access point to the destination device. Thus, the access point of a star topology or a daisy chain topology can be a choke point for communication within the network.

According to a particular aspect of the disclosure, reliance on the access point to route data is reduced by establishing a mesh network of peer devices. In the mesh network, communications can proceed from an originating device to a destination device without passing through an access point device. In a mesh topology there can be multiple paths to reach a destination device from an originating device.

According to a particular aspect, the originating device may receive network information descriptive of links between network devices, and may use the network information to determine a routing path for unicast communications (e.g., unicast packets) from the originating device to the destination device. The originating device takes into account a capacity of each link of the network, a utilization of each link of the network, other network information, or a combination thereof, to select the routing path. To illustrate, in some implementations, the originating device temporarily designates the destination device as an access point, executes uplink path determination instructions to determine the routing path, and subsequently de-designates the destination device as an access point. After selecting the routing path, the originating device sends routing data to other devices of the network. The routing data instructs the other devices of the network how to route unicast data that is from the originating device and directed to the destination device. For example, the routing data may inform a particular device to send the unicast data to another particular device as a next hop in the routing path.

In some circumstances, non-unicast communications (e.g., multicast packets or broadcast packets) can loop within a mesh network as a result of the multiple available paths in the mesh network. According to a particular aspect of the disclosure, looping of non-unicast communications is reduced or eliminated by determining a loop-free routing path for the non-unicast communications. After the loop-free routing path is determined (by one device, or by more than one device) and provided to the network devices, the network devices store routing data that is used to route non-unicast packets. For example, the routing data of a first network device may indicate that the first network device is to forward (e.g., retransmit) non-unicast packets received from a second network device, is to discard (e.g., not retransmit) non-unicast packets received from a third network device, or a combination thereof. By forwarding non-unicast packets received from particular network devices and not from other network devices, the first network device can prevent looping of the non-unicast packets within the mesh network.

According to a particular aspect, forming a mesh network and communicating via the mesh network includes discovering the mesh network or other devices capable of forming the mesh network, establishing the mesh network topology, and determining and communicating routing paths. As used herein, the term “unicast routing path” refers to a routing path for unicast communications. Generally, a unicast routing path describes each hop from an originating device to a destination device. Thus, a unicast routing path may also be referred to as an end-to-end routing path for unicast communications. As used herein, the term “non-unicast routing path” refers to a routing path for non-unicast communications, such as multicast communications or broadcast communications. As explained above, to reduce or eliminate looping of non-unicast packets, a non-unicast routing path is generally determined so as to prevent looping, and may therefore be referred to as a “loop-free routing path”.

One or more standardized communications protocols may be used to set up the mesh network and to communicate within the mesh network. For example, the mesh network may be advertised using beacon frames that conform to an IEEE 802.11 standard specification. In this example, an information element (e.g., one or more bits) of a beacon frame may be set to a value that indicates availability of a mesh network or availably of the device transmitting the beacon frame to participate in a mesh network. Additionally, standardized authentication processes, such as the port-based authentication of the IEEE 802.11 standards, can be used to authenticate devices joining the network, and standardized key exchange protocols can be used to derive or communicate encryption keys.

IEEE 802.11 standards generally refer to access points and stations, rather than peer devices as in a mesh network. For example, IEEE 802.11 standards may include distribution system (DS) fields, such as a “to DS” field and a “from DS” field, which indicate whether a packet is going to a distribution system or is coming from a distribution system. Data being transmitted from an originating device within a mesh network to a destination device within the mesh network is neither coming from a distribution system nor going to the distribution system. Accordingly, both the to DS field and the from DS field may be set to zero (0) in headers used to transmit data within the mesh network.

After multiple devices forming a mesh network have established communication links, network information describing the links may be exchanged between the devices. For example, each device may generate and send one or more IEEE 1905-compliant control message data units. A “control message data unit” refers to a communication frame as described by the IEEE 1905 specification or an extension of the IEEE 1905 specification. Control message data units can include link information, routing path information, or both. Examples of control message data units include IEEE 1905-compliant Notification frames, IEEE 1905-compliant Query frames, and IEEE 1905-compliant Report frames.

To generate the link information, each device gathers information for (e.g., takes measurements of) each of its links to other devices of the network. To illustrate, if a first network device has established a link to a second network device, the first network device gathers link information about the link, such as link capacity, link utilization, and so forth. The first network device also gathers link information regarding other links between the first network device and other network devices. The first network device may assemble the link information to form a link report.

Link reports are communicated between and among multiple network devices, such that each network device has network information descriptive of links of the network. For example, each network device may store network information descriptive of the entire network, including link information for each link of the network. The network information (or a portion thereof) may be sent to a new device when the new device joins the network. Additionally, the network information may be re-gathered and re-distributed occasionally. For example, the network information may be gathered again and distributed based on expiration of a timer. As another example, the network information may be gathered again and distributed based on detection of an event, such as an event indicating that a network configuration change occurs due to a device joining or leaving the network.

When a new device joins the network, neighbor devices of the new device send (e.g., broadcast) information indicating that a network topology change has occurred to other network devices. The information indicating that the network topology change has occurred may include updated network information, or the information indicating that a network topology change has occurred may prompt each network device to re-gather and re-distribute network information for the network.

In some implementations, the network information also includes information identifying resources available from one or more of the network devices. In other implementations, the network devices advertise available resources via another mechanism, such as via advertisement frames transmitted (e.g., broadcast) via the network. Examples of resources that a particular network device may make available via the network include access to another network (e.g., the particular network device may act as a gateway to another network, such as the internet), access to media (e.g., media streaming or teleconferencing) or other data (e.g., email), access to processing capacity (e.g., to share processor time), access to storage capacity (e.g., to act as shared storage), access to particular applications, or other sharable resources.

In a particular aspect, when network information is available to a network device, the network device uses the network information to determine one or more end-to-end routing paths for unicast communications. For example, a first network device may use the network information to determine unicast routing paths from the first network device to every other device of the network. In another example, the first network device may use the network information to determine unicast routing paths from the first network device to only a subset of the other devices of the network, such as a network device for which the first network device has unicast data, or a network device from which the first network device seeks data. Each routing path may be determined by identifying a set of potential routing paths between a network device performing the routing path determination (e.g., the originating device) and another network device (e.g., a destination device). The set of potential routing paths may include each possible, loop-free path from the originating device to the destination device, or may instead include a subset of the possible loop-free paths. After the set of potential routing paths has been identified, a “cost” associated with each potential routing path may be determined. For example, the cost of a potential routing path may be determined as a sum (or weighted sum) of the cost of each link in the routing path, and the cost of a link may be determined based on the link capacity, the link utilization, and a weighting factor. A lowest cost routing path of the set of potential routing paths may be selected as the routing path from the originating device to the destination device.

The originating device may send routing path information (e.g., via one or more control message data units) to network devices along the routing path. Since the originating device determines the full, end-to-end, routing path to the destination device for unicast packets sent from the originating device, the network devices on the routing path can simply store routing data (e.g., an entry of a routing table) that indicates a next hop device for unicast packets from the originating device to the destination device. Thus, for example, when a unicast packet bound for the destination device from the originating device is received at a particular network device, the particular network device selects a next hop device by consulting the routing data in a memory of the particular network device. Thus, next hop decisions at each network device can be reduced without including routing path information in a header or wrapper of each data packet.

Each network device may periodically or occasionally re-evaluate routing paths to other network devices. For example, as changes in network traffic patterns occur, link utilization of a particular link may change, which may cause a different routing path to be preferable (e.g., lower cost). If an originating device determines a new routing path to a destination device, the originating device sends updated routing path information to devices along the new routing path. Additionally, in some implementations, the orientating device may send the new routing path information (or other information) to network devices of the previous routing path so that the network devices of the previous routing path can remove or change routing data that does not correspond to the new routing path.

In some implementations, more than one type of data may be communicated between an originating device and a destination device. For example, when the originating device shares a teleconferencing resource with the destination device, video data and audio data may be communicated from the originating device to the destination device. In this example, the originating device may determine a different routing path for the video data than for the audio data. To illustrate, a weighting factor used to determine the routing path for the video data may favor high bandwidth links to provide a high bandwidth routing path for the video data. However, a weighting factor used to determine the routing path for the audio data may favor low latency links to provide a low latency routing path for the audio data.

In a particular implementation, an originating device determines a routing path by designating the destination device as a virtual access point. In this implementation, the originating device determines the routing path to the destination device by executing uplink routing path instructions to determine an uplink routing path to the virtual access point. After determining the routing path, the originating device de-designates the destination device as a virtual access point (e.g., designates the destination device as a station or peer device).

In addition to determining unicast routing paths, network devices of the mesh network may determine a loop-free routing path for non-unicast data (e.g., broadcast data and multicast data). For example, the loop-free routing path for non-unicast data may be determined by a single network device and distributed to other network devices. As another example, multiple network devices may use a distributed spanning tree determination process to determine the loop-free routing path. To illustrate, the network devices may exchange control message data units (e.g., IEEE 1905 frames) to communicate media access control (MAC) addresses and cumulative path weights between neighbor devices. A root network device may be selected based on the cumulative path weights, and the loop-free routing path may be determined such that every other network device of the network is connected to the root network device via a path that is devoid of loops.

After the loop-free routing path is determined, each network device stores routing data that identifies one or more neighbor devices for routing non-unicast data along the loop-free routing path. When a non-unicast packet is received at a network device, the network device determines whether the non-unicast packet was received from a neighbor device on the loop-free routing path based on the routing data. If the non-unicast data was received from a neighbor device on the loop-free routing path, the network device forwards (e.g., retransmits) the non-unicast packet. However, if the non-unicast packet was received from a network device that is not a neighbor device on the loop-free routing path, the network device drops the non-unicast packet to prevent loop formation.

Thus, in various aspects, the disclosure enables network devices to form a mesh network using standard communication protocols. The mesh network reduces dependence on a single access point to route data within the network.

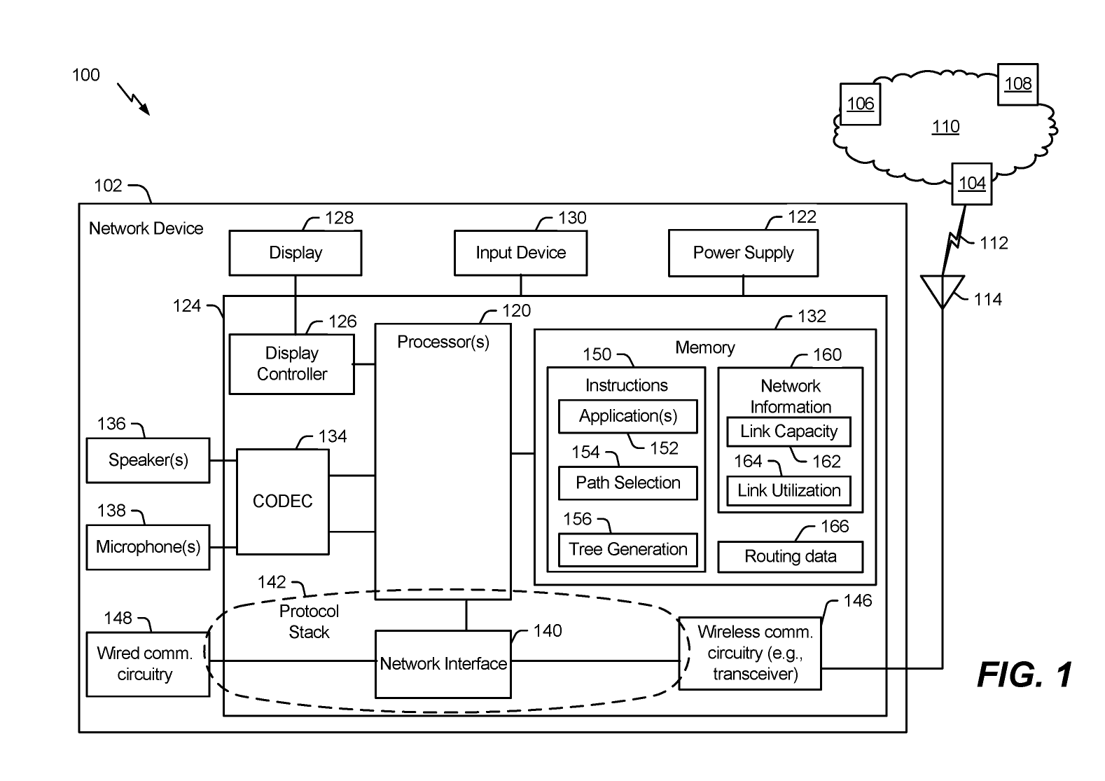

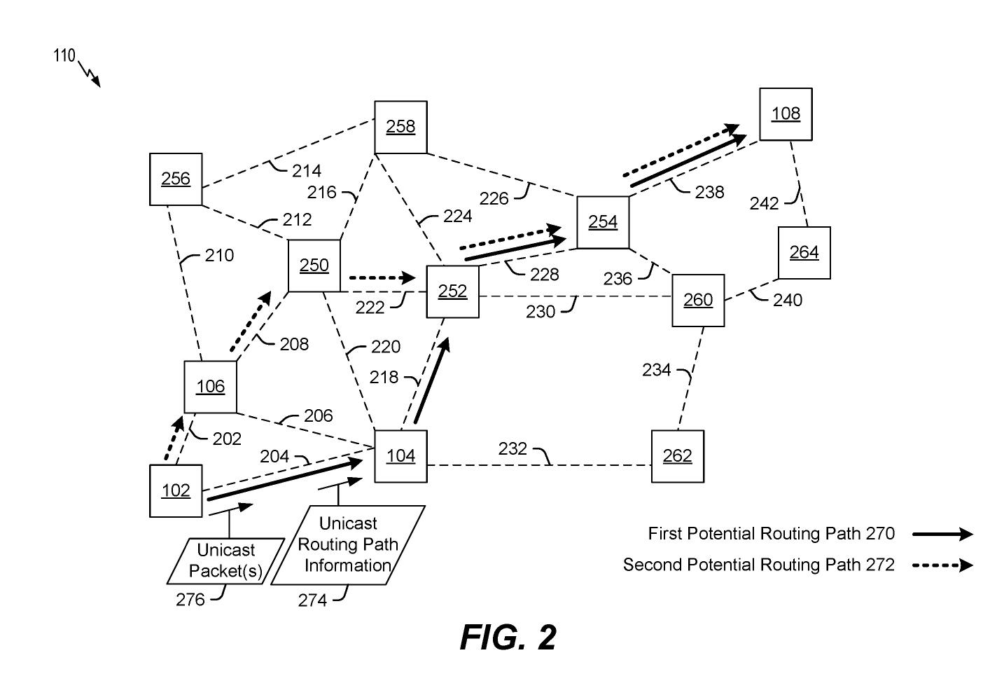

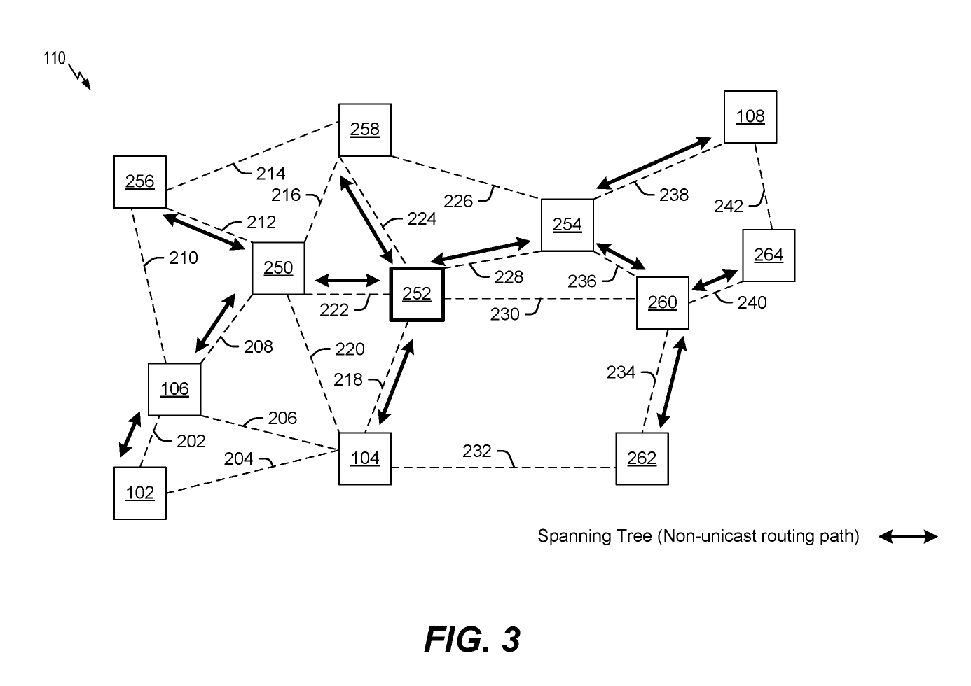

FIG. 1 is a diagram illustrating a system 100 including multiple network devices coupled via a network 110. For simplicity, in FIG. 1, four network devices 102, 104, 106 and 108 are illustrated; however, in other implementations, more than four or fewer than four network devices may be in the network 110. For example, FIGS. 2 and 3 are diagrams illustrating aspects of the network 110 of FIG. 1 and showing more devices in the network 110.

Additionally, a network device 102 is shown in more detail in FIG. 1 than are the other network devices 104, 106, and 108. The other network devices 104, 106, and 108 may be similar to the network device 102 or different from the network device 102. For example, the other network devices 104, 106, and 108 may include features and components similar to the features and components of the network device 102, or the other network devices 104, 106, and 108 may have different features or components, fewer feature or components, or more features or components than the network device 102.

In FIG. 1, the network device 102 may correspond to a mobile device, such as a mobile telephone, a portable hotspot, a portable computer, a personal internet of things device (e.g., a smart watch, a wearable sensor, a wearable camera), a mobile internet of things device (e.g., a network connected toy, a wireless camera), a component of a vehicle (e.g., an automobile-based network device), etc. Alternatively, the network device 102 may correspond to a stationary device, such as a base station, a desktop computer, a server computer, a set-top box device, a router device (e.g., a wireless router), an infrastructure internet of things device (e.g., a thermostat or lighting fixture), etc. In other examples, the network device 102 may include or correspond to a cellular phone, a smartphone, a tablet, a wireless modem, a personal digital assistant (PDA), a handheld device, a laptop computer, a smartbook, a netbook, a tablet, a cordless phone, a wireless local loop (WLL) station, a Bluetooth device, etc.

The first network device includes a memory 132 and a processor 120 (e.g., a digital signal processor or central processing unit). The memory 132 may be coupled to or integrated with the processor 120. According to one implementation, the memory 132 is a non-transitory computer-readable medium that includes (e.g., stores data corresponding to) instructions 150 for performing the techniques described herein. For example, the instructions 150 may include path selection instructions 154 that are executable by the processor 120 to determine a unicast routing path from the network device 102 to another network device, such as a network device 108, as described further with reference to FIG. 2. As another example, the instructions 150 may include tree generation instructions 156 that are executable by the processor 120 to determine a loop-free routing path for non-unicast data, as described further with reference to FIG. 3. The instructions 150 may also include one or more applications 152 which are executable by the processor 120 to generate data to be sent to another network device 104, 106, or 108 via the network 110, or to receive and use data sent from another network device 104, 106, or 108 via the network 110. For example, the applications 152 may be executable to provide a resource that is made available for use by the other network devices 104, 106, or 108.

The memory 132 may also store network information 160 and routing data 166. The network information 160 is descriptive of links between network devices of the network 110, such as a link between a network device 104 and a network device 108. In the example illustrated in FIG. 1, the network information 160 includes link capacity data 162 and link utilization data 164; however, in other examples, the network information 160 may include more data, less data, or different data. The network information 160 may include data provided by other network devices 104, 106, 108 regarding links between pairs of the other network devices 104, 106, 108, as described further with reference to FIG. 2. Additionally, the network information 160 may include information generated by the network device 102, such as by measuring a wireless link 112 between the network device 102 and the network device 104.

In a particular implantation, the routing data 166 includes a routing table including one or more routing table entries. Each routing table entry includes information generated by the path selection instructions 154 or information provided by the other network devices 104, 106, 108. For example, as described further below, the path selection instructions 154 may determine a routing path from the network device 102 to the network device 108. In this example, routing path information describing the routing path may be sent via the wireless link 112 to the network device 104 (as well as to one or more other network devices 106, 108). The routing path information may also be stored in the memory 132 as a routing table entry in the routing data 166. In another example, another network device may send routing path information to the network device 102 and the routing path information from the other network device may be stored in the memory 132 in the routing data 166. To illustrate, the network device 108 may determine a routing path to a network device 106, and the network device 108 may send, to the network device 102, routing path information describing the routing path. In this example, the network device 102 stores the routing path information in a routing table entry in the routing data 166 for use in routing unicast packets from the network device 108 to the network device 106.

The processor 120 is configured to access the memory 132 to store, retrieve, or use the network information 160, to store, retrieve, or use the routing data 166, and to execute the instructions 150. The network device 102 also includes other components to facilitate communication via the network 110, such as communication circuitry. For example, in FIG. 1, the communication circuitry includes a network interface 140, wireless communication circuitry 146, and wired communication circuitry 148. In this example, the network interface 140 facilitates (or controls) communication between the wireless communication circuitry 146 and the processor 120, between the wired communication circuitry 148 and the processor 120, or both. Together, the processor 120 and the communication circuitry implement a protocol stack 142 to facilitate communications via the network 110. In a particular implementation, the protocol stack 142 is compliant with one or more IEEE standards, such as an IEEE 1905.1 specification (which may be extended to enable communication of routing path information via control message data units) and an IEEE 802.11 specification. In this implementation, the instructions 150 include IEEE 1905.1 compliant protocol stack instructions that are executable to generate CMDUs at an abstraction layer between a physical layer and a network layer of the protocol stack 142.

The wireless communication circuitry 146 includes a receiver and a transmitter, or a combination thereof (e.g., a transceiver). The wireless communication circuitry 146 may also include other radiofrequency (RF) components, such as an RF frontend, an interface to an antenna 114, a matching network, etc. Although only a single antenna 114 is illustrated in FIG. 1, the network device 102 may include more than one antenna. For example, the network device 102 may include multiple wireless communication circuits (e.g., multiple transmitters and receivers) coupled to an array of antennas. In this example, the array of antennas may be configured to wirelessly communicate with one or more other network devices 104, 106, 108. Further, in this example, the wireless communication circuitry 146 may be configured to support multiple input-multiple output (MIMO) communications.

The wired communication circuitry 148 includes a wireline connector port (e.g., a universal serial bus (USB) port, a mini USB port, a micro USB port, an Ethernet port, etc.), a port controller (e.g., a USB port controller), other circuit components to communicate data via a wireline connection, or a combination thereof. Although, the wired communication circuitry 148 is illustrated in FIG. 1 as a single component, in some implementations, the wired communication circuitry 148 may include multiple wired communication ports of the same type (e.g., two or more USB ports), of different types (e.g., one USB and one Ethernet port), or a combination there of (e.g., multiple USB ports and one Ethernet port). Further, in some implementations, the network device 102 does not include the wired communication circuitry 148.

The network device 102 may also include a power supply 122 and other components. Generally, the other components enable the network device 102 to interact with a user (e.g., to display information, to receive input, or to output audio). For example, the network device 102 may include a coder/decoder (CODEC) 134. The CODEC 134 may be coupled to the processor 120 and to one or more speakers 136, one or more microphones 138, or both. The network device 102 may also include a display controller 126 coupled to the processor 120 and to a display device 128. The network device 102 may also include an input device 130, such as a keyboard, one or more buttons, a camera, a sensor, a touchscreen, a fingerprint reader, etc.

In a particular implementation, the processor 120, the display controller 126, the memory 132, the CODEC 134, and the wireless communication circuitry 146 are included in a system-in-package or system-on-chip device 124. In this particular implementation, the input device 130 and the power supply 122 are coupled to the system-on-chip device 124. Moreover, as illustrated in FIG. 1, the display device 128, the input device 130, the one or more speakers 136, the one or more microphones 138, the antenna 114, and the power supply 122 are external to the system-on-chip device 124. However, each of the display device 128, the input device 130, the one or more speakers 136, the one or more microphones 138, the antenna 114, and the power supply 122 can be coupled to one or more components of the system-on-chip device 124, such as one or more interfaces or controllers.

FIGS. 2 and 3 are diagrams illustrating further aspects of the network 110. In particular, FIG. 2 illustrates determining an end-to-end routing path for unicast communications (also referred to herein as a “unicast routing path”), and FIG. 3 illustrates determining a loop-free routing path for non-unicast communications (also referred to herein as a “non-unicast routing path”). In FIGS. 2 and 3, the network 110 includes the network device 102, the network device 104, the network device 108 and the network device 106. Additionally, the network 110 includes a plurality of other network devices, including network devices 250, 252, 254, 256, 258, 260, 262, and 264. Although the network 110 is shown in FIGS. 2 and 3 with twelve network devices, in other implementations, the network 110 may include more than twelve network devices or fewer than twelve network devices. The network devices 104, 106, 108, 250, 252, 254, 256, 258, 260, 262, and 264 may each include similar components and perform similar functions as described with reference to the network device 102 in FIG. 1. Alternatively, one or more of the network devices 104, 106, 108, 250, 252, 254, 256, 258, 260, 262, and 264 may include more components or fewer components than the network device 102. For example, one or more of the network devices 104, 106, 108, 250, 252, 254, 256, 258, 260, 262, and 264 may act as a network repeater, a router, or an internet of things device, and accordingly, may include only a subset of the components described with reference to the network device 102.

In FIGS. 2 and 3, the network devices 102, 104, 106, 108, 250, 252, 254, 256, 258, 260, 262, and 264 have established communication links (“links”) 202-242. For example, each link may be established using beaconing, authentication, handshakes, and key exchange processes as specified by various communication standards, such as various IEEE specifications. Although no directionality is illustrated in FIGS. 2 and 3, each link may be unidirectional or bidirectional. For example, the link 202 between the network device 102 and the network device 106 may be a single link or may include two one-way links (e.g., a first one-way link from the network device 102 to the network device 106 and a second one-way link from the network device 106 to the network device 102).

Each link 202-242 is associated with link information. As described above, the link information may include link capacity, link utilization, other information, or a combination thereof. The link information for a particular link may be determined by one of the network devices associated with the particular link. For example, link information for the link 202 may be determined by the network device 102, by the network device 106, or both. The link information may be determined based on measurements taken by the network device. Examples of measurements that may be performed by a network device to determine the link information include a measurement of signal-to-noise ratio, a measurement of packet loss, and a measurement of a throughput rate. Alternatively, or in addition, the link information may be determined based on link configuration information available to the network device. Examples link configuration information that may be used to determine the link information include a modulation scheme used by the link, a negotiated data rate associated with the link, a throughput limit of the network device, and a data priority scheme used by the link. In a particular implementation, both measurements and configuration information are used to determine the link information.

After a particular network device determines link information for each of the particular network device's links, the particular network device sends (e.g., broadcasts) one or more control message data units including the link information. In addition to transmitting its own link information, each network device 102, 104, 106, 108, 250, 252, 254, 256, 258, 260, 262, 264 may forward (according to a loop-free spanning tree) control message data units including link information from other network devices. Thus, eventually, each network device 102, 104, 106, 108, 250, 252, 254, 256, 258, 260, 262, 264 receives network information descriptive of the links 202-242 between the network devices 102, 104, 106, 108, 250, 252, 254, 256, 258, 260, 262, and 264 of a network 110.

After a particular network device receives the network information, the particular network device determines an end-to-end routing path for unicast communications to another network device. Additionally, the particular network device may determine, alone or in cooperation with other network devices, a loop-free routing path for non-unicast communications. FIG. 2 illustrates determining and using the end-to-end routing path for unicast communications, and FIG. 3 illustrates determining and using the loop-free routing path for non-unicast communications.

In FIG. 2, the network device 102 determines, based on network information descriptive of the links 202-242 between network devices 102, 104, 106, 108, 250, 252, 254, 256, 258, 260, 262, 264, a unicast routing path (e.g., an end-to-end routing path for unicast communications) to the network device 108. To determine the unicast routing path, the network device 102 may first determine a set of potential routing paths, such as a first potential routing path 270 and a second potential routing path 272. In the first potential routing path 270, a unicast packet is sent from the network device 102 to the network device 104, which sends the unicast packet to the network device 252, which sends the unicast packet to the network device 254, which sends the unicast packet to the network device 108. Thus, the first potential routing path 270 traverses links 204, 218, 228, and 238. In the second potential routing path 272, a unicast packet is sent from the network device 102 to the network device 106, which sends the unicast packet to the network device 250, which sends the unicast packet to the network device 252, which sends the unicast packet to the network device 254, which sends the unicast packet to the network device 108. Thus, the second potential routing path 272 traverses links 202, 208, 222, 228, and 238. Although only two potential routing paths are highlighted in FIG. 2, it should be clear from FIG. 2 that other potential routing paths are also possible, and have been omitted for clarity.

After determining the set of potential routing paths, the network device 102 may determine an end-to-end cost value for each potential routing path. For example, a first end-to-end cost value associated with the first potential routing path 270 may be determined based on link costs of the links 204, 218, 228, and 238 of the first potential routing path 270. Each link cost may be based on a respective link capacity and based on a respective link utilization. As a specific example, the first end-to-end cost value may include a weighted sum of link costs of the links 204, 218, 228, and 238. Similarly, a second end-to-end cost value associated with the second potential routing path 272 may be determined based on link costs of the links 202, 208, 222, 228, and 238 of the second potential routing path 272.

The network device 102 compares the end-to-end cost values for the potential routing paths 270, 272 and selects a lowest cost routing path as the unicast routing path from the network device 102 to the network device 108. In a particular implementation, the process of selecting the unicast routing path is simplified when the network device 102 includes instructions to determine an uplink routing path to an access point. In this implementation, the network device 102 designates the network device 108 as an access point (e.g., a virtual access point) and executes the instructions to determine the uplink routing path to an access point with the network device 108 designated as the access point. In this example, the network device 102 uses a process designed to determine routing paths in a network having a star or daisy chain topology to determine routing paths for a network having a mesh topology.

In the particular example illustrated in FIG. 2, the first potential routing path 270 is selected as the unicast routing path from the network device 102 to the network device 108. After determining the unicast routing path, the network device 102 may send, via one or more control message data units, unicast routing path information 274 to each network device on the routing path. For example, in FIG. 2, the network device 102 may send the unicast routing path information 274 to the network device 104, to the network device 252, and to the network device 254. The unicast routing path information 274 may also be sent to the network device 108 in some implementations. Note that the unicast routing path is unidirectional. Accordingly, unicast communications sent from the network device 108 to the network device 102 may follow a “reverse” routing path determined by the network device 108. The network device 108 may determine the reverse routing path independently of routing path determinations performed by the network device 102. Accordingly, the reverse routing path may traverse the same network devices and links as the routing path or may traverse a different set of network devices and links.

Each network device 104, 252, 254 that receives the unicast routing path information 274 may store routing data (e.g., an entry in a routing table). The routing data indicates a next hop network device for a unicast packet based on a network device that originated the unicast packet (e.g., an originating device) and based on a destination device of the unicast packet. For example, when the network device 102 sends unicast packets 276 to the network device 108, the unicast packets 276 may include header information identifying the network device 102 as the originating device and identifying the network device 108 as the destination device. When the network device 104 receives one of the unicast packets 276, the network device 104 access routing data stored at the network device 104 to determine a next hop network device of the unicast packet based on the originating device and the destination device. Accordingly, the unicast packets 276 can omit routing information.

The network information may be updated periodically or occasionally. For example, the network information may be updated when the network configuration changes, such as if the network device 250 leaves the network. As another example, the network information may be updated when the network conditions changes, such as if the link 222 experiences congestion or delays. As another example, the network information may be updated based on expiration of a timer. The timer may, for example, track an interval since detection of a heart beat signal from a network device of the network 110, track an interval since a prior end-to-end routing path was determined, or track an interval since prior network information was received. When the network information is updated, the network devices 102, 104, 106, 108, 250, 252, 254, 256, 258, 260, 262, 264 may go through the routing path determination process again using the updated network information. For example, the network device 102 may determine a set of potential routing paths based on the updated network information, and may select one of the potential routing paths as the unicast routing path to another network device.

The example in FIG. 2 illustrates selection of a single unicast routing path for all unicast communications from the network device 102 to the network device 108. However, in other implementations, different unicast routing paths may be determined for different types of data sent from the network device 102 to the network device 108. For example, a first unicast routing path may be determined for a first type of data (e.g., audio data), and a second unicast routing path may be determined for a second type of data (e.g., video). Additionally, the example in FIG. 2 illustrates determining a unicast routing path from the network device 102 to only one other network device (i.e., the network device 108). However, in some implementations, the network device 102 determines a unicast routing path to each of the other network devices 104, 106, 108, 250, 252, 254, 256, 258, 260, 262, 264. In other implementations, the network device 102 determines a unicast routing path to a subset of the other network devices 104, 106, 108, 250, 252, 254, 256, 258, 260, 262, 264, where the subset includes each network device for which the network device 102 has data that is to be sent via unicast.

FIG. 3 illustrates an example of a loop-free routing path in the network for transmission of non-unicast packets (e.g., broadcast packets or multicast packets). The loop-free routing path may be determined by a single network device, such as the network device 252 or the network device 102. Alternatively, the network devices 102, 104, 106, 108, 250, 252, 254, 256, 258, 260, 262, 264 or a subset of the network devices 102, 104, 106, 108, 250, 252, 254, 256, 258, 260, 262, 264 may cooperate to determine the loop-free path using a distributed spanning tree determination process.

In a particular implementation, the loop-free routing path (or spanning tree) is determined by selecting a root device. In FIG. 3, the network device 252 is the root device. The spanning tree includes a set of routing paths from the root device along which non-unicast packets are forwarded (either toward the root device or away from the root device). The set of routing paths is arranged such that every network device is connected to another network device via at least one routing path. Stated another way, the spanning tree includes every network device of the network 110. Additionally, the spanning tree is arranged such that no subset of the routing paths form a loop.

Each network device forwards (e.g., retransmits) a non-unicast packet that is received from a neighbor device of the spanning tree, and drops (e.g., does not retransmit) a non-unicast packet received from network devices that are not neighbor devices of the spanning tree. For example, if the network device 254 transmits a non-unicast packet (e.g., a broadcast packet or a multicast packet), network devices within communication range of the network device 254 may receive the non-unicast packet. In the example, illustrated in FIG. 3, the network devices within communication range of the network device 254 include at least the network devices 260, 108, 258, 252. Although no link is shown between network device 254 and network device 264, the network device 264 may also be within communication range of the network device 254 and may receive the non-unicast packet. Thus, the network devices 260, 108, 258, 252, and 264 may receive the non-unicast packet transmitted by the network device 254.

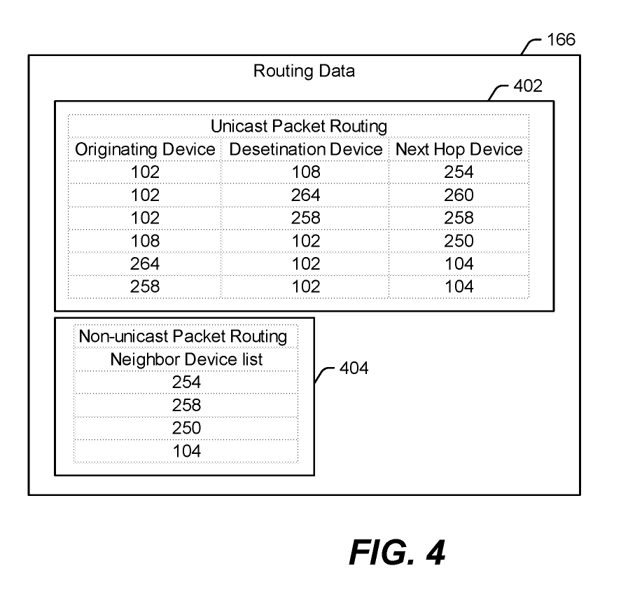

Each of the network devices 260, 108, 258, 252, 264 may include a memory that stores routing data (such as the routing data 166 of FIG. 1 and FIG. 4). The network devices 260, 108, 258, 252, 264 may determine, based on their respective routing data, whether the non-unicast packet was received from a neighbor device on the spanning tree. If a particular network device determines that the non-unicast packet was received from a neighbor device on the spanning tree, the particular network device forwards (e.g., retransmits) the non-unicast packet. However, if the particular network device determines that the non-unicast packet was not received from a neighbor device on the spanning tree, the particular network device drops (e.g., does not retransmit) the non-unicast packet. To illustrate, based on the spanning tree of FIG. 3, the network device 254 is not a neighbor device of the network devices 264 and 258. Accordingly, the network devices 264 and 258 would not retransmit the non-unicast packet. However, the network devices 252 and 260 are neighbor devices of the network device 254. Accordingly, the network devices 252 and 260 would retransmit the non-unicast packet.

FIG. 4 is a diagram illustrating routing data 166 of a particular network device of the network 110 of FIG. 1. In particular, the routing data 166 illustrated in FIG. 4 may be stored at the network device 252 of FIGS. 2 and 3. The routing data 166 includes a first set of routing table entries for unicast routing data 402 and a second set of routing table entries for non-unicast routing data 404. To simplify cross-reference to FIGS. 2 and 3, entries in the routing data 166 are illustrated with reference numerals corresponding to network devices in FIGS. 2 and 3. For example, a first entry of the non-unicast routing data 404 is “254” corresponding to the network device 254 and indicating that the network device 254 is a neighbor device.

The unicast routing data 402 includes one or more entries that map an originating device and a destination device of particular unicast packet to a next hop device. For example, a unicast packet may include header information identifying the originating device of the unicast packet and identifying the destination device of the unicast packet. In a particular aspect, the unicast packet may not include details of a routing path from the originating device to the destination device. Accordingly, a network device that receives the unicast data packet may access the unicast routing data 402 to determine where to send the unicast packet (e.g., to identify a next hop device along the routing path).

As a specific example, in FIG. 4, the unicast routing data 402 indicates that when the network device 252 receives a unicast packet that identifies the network device 102 as the originating device and the network device 108 as the destination device, the network device 254 is the next hop device. Thus, the network device 252 forwards (e.g., retransmits) the unicast packet to the network device 254.

The unicast routing data 402 also identifies next hop devices for several other unicast routing paths, such as a routing path from the network device 102 to the network device 264, a routing path from the network device 102 to the network device 258, a routing path from the network device 108 to the network device 102, a routing path from the network device 264 to the network device 102, and a routing path from the network device 258 to the network device 102. While the unicast routing data 402 illustrates several routing paths toward the network device 102 and several routing paths from the network device 102, the unicast routing data 402 may also include data corresponding to routing paths to or from other network device of the network 110.

The non-unicast routing data 404 identifies one or more neighbor devices of the spanning tree of FIG. 3. For example, in FIG. 3, the spanning tree shows that network devices 254, 258, 250 and 104 are neighbor devices of the network device 252. Accordingly, the network devices 254, 258, 250 and 104 are identified in the non-unicast routing data 404. Based on the non-unicast routing data 404, if the network device 252 receives a non-unicast packet from one of the network devices 254, 258, 250 and 104, the network device 252 will retransmit the non-unicast packet. However, if the network device 252 receives a non-unicast packet from any device other than one of the network devices 254, 258, 250 and 104, the network device 252 will not retransmit the non-unicast packet.

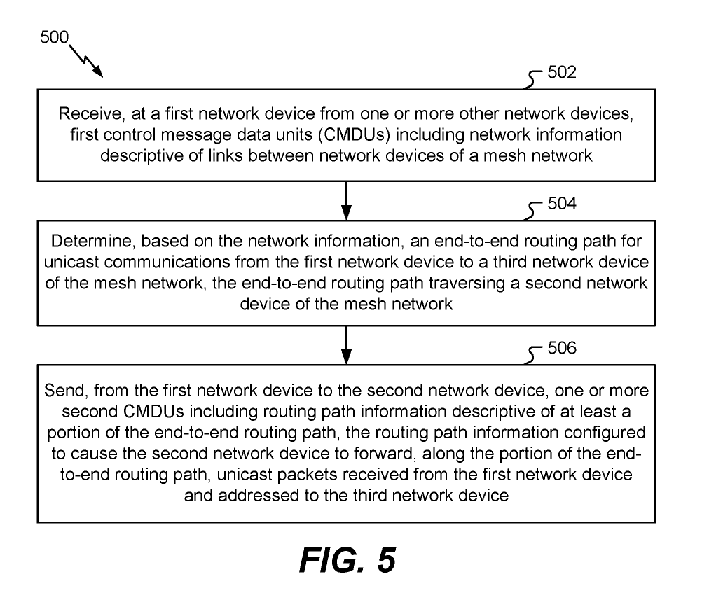

Referring to FIG. 5, an example of a method 500 of determining and sending routing path information is depicted. The method 500 may be performed at a network device, such as one or more of the network devices 102, 104, 106, or 108 of FIG. 1. For example, the method 500 may be performed in response to the network device 102 joining a self-organizing network (SON) with a mesh topology. As another example, the method 500 may be performed periodically or in response to detection of an event.

The method 500 includes, at 502, receiving, at a first network device from one or more other network devices, first control message data units (CMDUs) including network information descriptive of links between network devices of a mesh network. For example, the network information may indicate a link capacity of each of the links and may indicate a link utilization of each of the links. To illustrate, the network device 102 of FIG. 1 may receive link capacity and link utilization information from the network device 104 via CMDUs according to an IEEE 1905 specification.

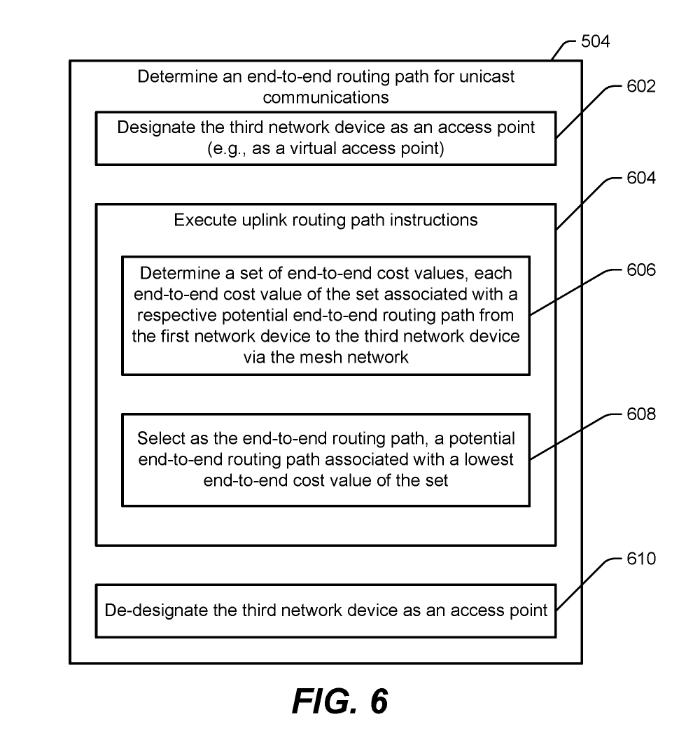

The method 500 includes determining, based on the network information, an end-to-end routing path for unicast communications from the first network device to a third network device of the mesh network, the end-to-end routing path traversing a second network device of the mesh network, at 504. For example, the end-to-end routing path for unicast communications may be determined as described with reference to FIG. 2. An example implementation of determining the end-to-end routing path for unicast communications is described in further detail with reference to FIG. 6.

The method 500 includes sending, from the first network device to the second network device, one or more second CMDUs including routing path information descriptive of at least a portion of the end-to-end routing path, at 506. In some implementations, the routing path information causes the second network device to forward, along the portion of the end-to-end routing path, unicast packets received from the first network device and addressed to the third network device.

By sending routing path information to other devices along the end-to-end routing path, the other devices may store at least a portion of the routing path information that identifies a next hop device along the end-to-end routing path. A unicast packet may therefore be sent from an originator device and to a destination device with a header that identifies the originator device and the destination device and omits reference to any intermediate hop devices of the end-to-end routing path. Each of the devices along the end-to-end routing path sends the unicast packet to the next sequential device along the end-to-end routing path despite the unicast packet not specifying the next sequential device along the end-to-end routing path.

FIG. 6 depicts an example of operations that may be performed to determine the end-to-end routing path at 504 of FIG. 5. In the illustrated implementation, determining the end-to-end routing path includes designating the third network device as an access point, at 602, and executing uplink routing instructions to determine an uplink routing path to an access point to determine the end-to-end routing path, at 604. For example, the network device 102 may implement a protocol stack that supports joining a network having a star topology or a daisy-chain topology with a single access point, such as an IEEE 1905.1-compliant protocol stack. The protocol stack may include a path selection module that determines a routing path between the network device 102 and the single access point. To use the protocol stack in conjunction with a self-organizing mesh network topology, the network device 102 may identify another network device as an access point in order to operate the path selection module to determine a routing path to the other network device.

Executing the instructions to determine the uplink routing path to an access point may include determining a set of end-to-end cost value, where each end-to-end cost value is associated with a respective potential routing path, at 606. For example, a first end-to-end cost value may be based on a respective link capacity of each link of a first potential routing path and based on a respective link utilization of each link of the first potential routing path. Similarly, a second end-to-end cost value may be based on a respective link capacity of each link of a second potential routing path and based on a respective link utilization of each link of the second potential routing path. Executing the instructions to determine the uplink routing path to an access point also includes selecting as the end-to-end routing path, a potential end-to-end routing path associated with a lowest end-to-end cost value of the set, at 608.

The method also includes, at 610, after determining the end-to-end routing path, de-designating the third network device as an access point. One or more other unicast routing paths to one or more other network devices may be determined by repeating 602-610 for each of the one or more other network devices.

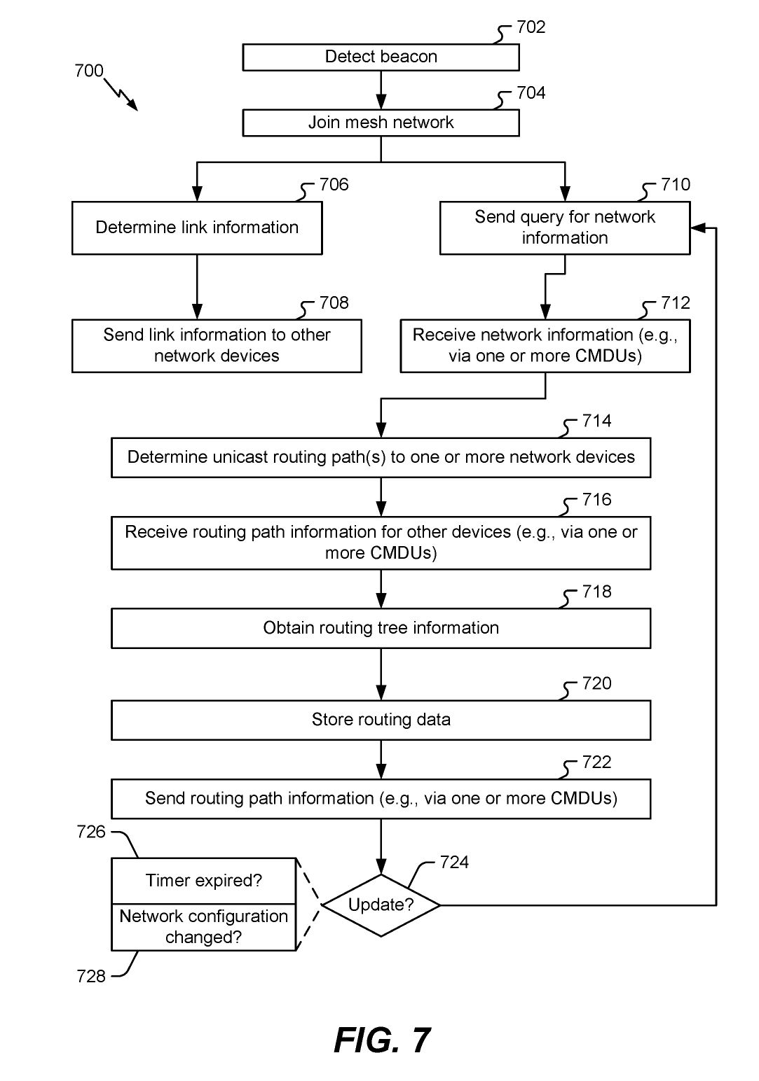

FIG. 7 illustrates an example of a method 700 performed at a network device, such as one or more of the network devices 102, 104, 106, or 108 of FIG. 1. For example, the method 700 may be performed by a first network device in conjunction with the network device 102 joining a self-organizing network (SON) with a mesh topology, such as the network 110 of FIGS. 2 and 3.

The method 700 includes detecting a beacon, at 702, and joining the mesh network, at 704. For example, the first network device may be configured to implement the protocol stack 142 of FIG. 1, to detect an IEEE 802.11-type beacon, and to join a mesh network associated with the beacon. Joining the mesh network includes establishing communication links with one or more other network devices, exchanging authentication information, negotiating communication settings, etc.

The method 700 includes determining link information descriptive of links between the first network device and one or more neighbor devices, at 706. For example, the network device 102 may support discovery messages to detect neighbor network devices and may support a mechanism to obtain (e.g., determine or receive from another network device) a list of metrics for links to the neighbor network devices, such as a packet error metric, a transmitted packet metric, a media access control (MAC) throughput capacity, link availability (e.g., as a percentage of time that the link is idle), and a physical layer (PHY) transfer rate.

The method 700 also includes sending the link information (or a portion thereof) to one or more other network devices, at 708. For example, the network device 102 may be configured to operate in accordance with an IEEE 1905.1-type protocol that supports receiving link metric query CMDUs from other network devices and sending link metric response CMDUs to the requesting devices.

The method 700 also includes, at 710, send a query for network information and, at 712, receiving the network information. For example, the method 700 may include sending, from the first network device to a second network device, a query for the network information, and the network information may be received after sending the query. For example, the network device 102 may be configured to operate in accordance with an IEEE 1905.1-compliant protocol that supports sending link metric query messages to other network devices via one or more CMDUs and receiving link metric response messages from the other network devices via one or more CMDUs.

The method 700 also includes, at 714, determining, at the first network device, one or more unicast routing paths to one or more other network devices, at 714. For example, the first network device may perform at least a portion of the method 500 of FIG. 5 or of the operations described in FIG. 6 to determine an end-to-end routing path for unicast communications to a third network device based on the received network information. The first network device may determine one or more additional unicast routing paths from the first network device to the other network devices based on the network information. The first network device may also receive routing path information from other devices, at 716. For example, the received routing path information may be received via one or more CMDUs and may indicate a unicast routing path (or a portion of a unicast routing path) from an originating network device to a destination network device.

In addition to determining unicast routing paths to one or more other device(s) in the network and receiving unicast routing path information from one or more other device(s), the first network device may be included in a loop-free spanning routing tree that includes all network devices of the network. For example, the first network device may obtain (e.g., determine or receive from another device) routing tree information, at 718, such as for a loop-free spanning tree used for non-unicast packet (e.g., broadcast packet or multicast packet) routing.

The method 700 includes storing routing data, at 720. For example, the first network device may store its determined unicast routing paths in a first set of routing data. The first network device may also store the received routing path information for the other devices. For example, the first network device may store a routing table entry indicating that when a unicast packet is received from a particular originating network device and to a particular destination network device, the message is to be forwarded to a next device or “hop” along a unicast routing path. The first network device may also store at least a portion of the routing tree information identifying the first network device's neighbors on the routing tree.

The method 700 also includes sending routing path information, at 722. For example, the first network device may send routing path information to all devices along a first unicast routing path from the first network device to the third network device that is determined according to the method 500 of FIG. 5. The first network device may send, to at least one other network device, additional unicast routing path information descriptive of one or more additional unicast routing paths. In some implementations, the routing path information is sent via one or more CMDUs of an extended IEEE 1905.1-compliant protocol.

A determination may be made, at 724, as to whether network information is to be updated. For example, in response to a determination of a network configuration change, at 728, one or more operations associated with 710-722 of FIG. 7 may be repeated. As an illustrative, non-limiting example, determining unicast routing path(s), at 714, and sending the unicast routing path information, at 722, may be performed responsive to a network configuration change. The network configuration change may correspond to the first network device joining the network. As another example, the network configuration change may correspond to the second network device or the third network device joining the network. Alternatively, or in addition, the network configuration change may correspond to a device leaving the network.

In some implementations, a determination to update the network information, at 724, is made in response to determining expiration of a timer, at 726. As an illustrative, non-limiting example, determining unicast routing path(s), at 714, and sending the unicast routing path information, at 722, may be performed responsive to expiration of the timer. The timer may track an interval since detection of a heart beat signal from a device of the network. Alternatively, or in addition, the timer may track an interval since a prior unicast routing path was determined, an interval since prior network information was received, or a combination thereof.

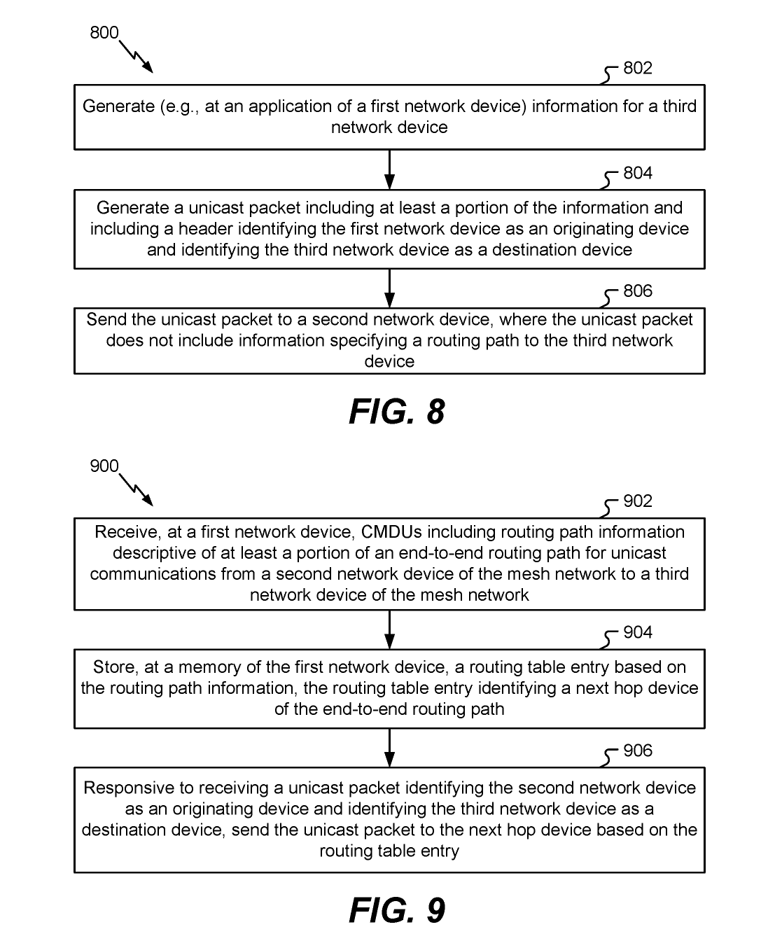

Referring to FIG. 8, an example of a method 800 of sending information via a unicast packet is depicted. The method 800 may be performed at a network device, such as one or more of the network devices 102, 104, 106, or 108 of FIG. 1. For example, the method 800 may be performed by the network device 102.

The method 800 includes generating information for a third network device, at 802. For example, the information may be generated by the processor 120 of the network device 102 executing the application(s) 152 of FIG. 1. The information may be generated to be sent to network device 108 of FIG. 1.

The method 800 includes generating, at the first network device, a unicast packet for the third network device, at 804. The unicast packet includes at least a portion of the information and a header identifying the network device 102 as an originating device and identifying the network device 108 as a destination device.

The method 800 includes sending the unicast packet to a second network device, where the unicast packet does not include information specifying a routing path to the third network device, at 806. To illustrate, the unicast packet may identify the first network device as the originating device and may identify the third network device as the destination device, without specifying a routing path between the first network device and the third network device. Each device along the routing path may access stored routing information to identify a next hop device of unicast packet traffic from the network device 102 to the network device 108.

As an example, the network device 102 of FIG. 2 may send a unicast packet to the network device 104. In this example, the unicast packet identifies the network device 108 as the destination device but does not including routing path information associated with the routing path 270. That is, the unicast packet does not identify any intermediate device (the network devices 104, 252, 254) along the routing path 270. In this example, the network device 104 may access routing data, such as the routing data 166 of FIG. 4, in a memory of the network device 104 to determine a next hop device, such as the network device 252.

By sending unicast packets that omit a full routing path and that instead list the originating device and the destination device, packet size may be reduced. As a result, link usage and usage of transmission resources may be reduced along each hop of the routing path.

Referring to FIG. 9, an example of a method 900 of forwarding a unicast packet is depicted. The method 900 may be performed at a network device, such as one or more of the network devices of FIGS. 1-3. For example, the method 900 may be performed by the network device 252 of FIG. 2.

The method 900 includes receiving, at a first network device, CMDUs including routing path information descriptive of at least a portion of an end-to-end routing path for unicast communications from a second network device of the mesh network to a third network device of the mesh network, at 902. For example, the first network device may correspond to the network device 252 of FIG. 2 that receives routing path information identifying at least a portion of an end-to-end routing path from the network device 102 to the network device 108.

The method 900 also includes, at 904, storing at a memory of the first network device, a routing table entry based on the routing path information. The routing table entry identifies a next hop device of the end-to-end routing path. For example, network device 252 may store a routing table entry in the unicast routing data 402 of FIG. 4. In this example, the routing table entry identifies a next hop device (e.g., the network device 254) of the end-to-end routing path.

The method 900 also includes, at 906, responsive to receiving a unicast packet identifying the second network device as an originating device and identifying the third network device as a destination device, sending the unicast packet to the next hop device based on the routing table entry. For example, based on the routing table entry identifying the network device 254 as the next hop device, the network device 252 sends the unicast packet to the network device 254.

By accessing stored routing data to forward unicast packets that omit a full routing path and that instead list the originating device and the destination device, packet size of the unicast packets can be reduced. As a result, link usage and usage of transmission resources may be reduced along each hop of the routing path.

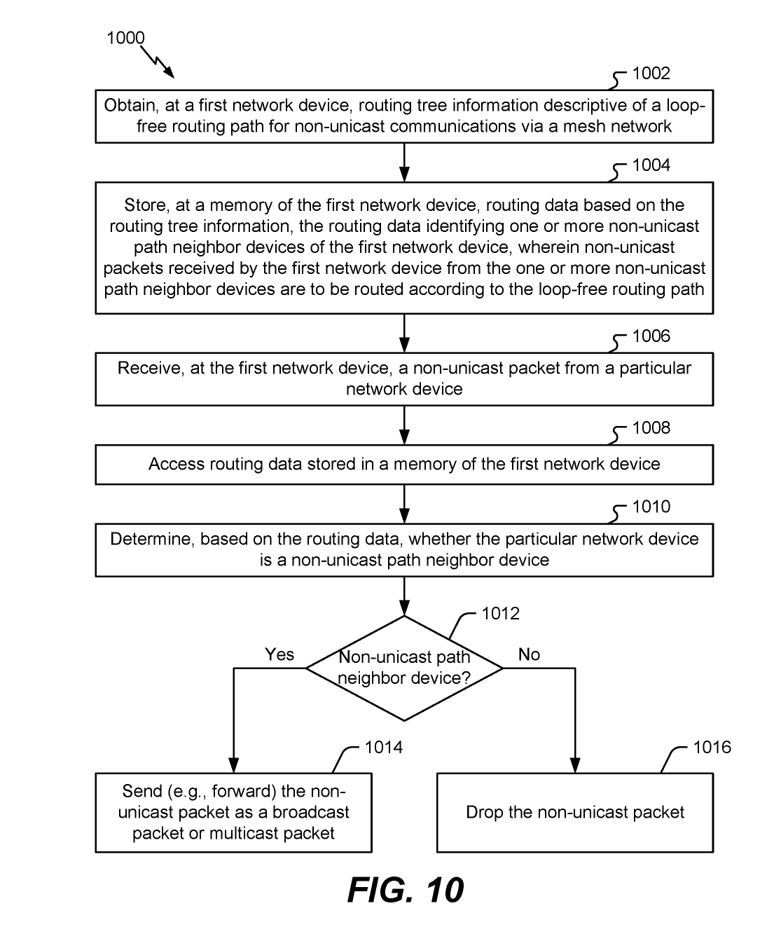

Referring to FIG. 10, an example of a method 1000 of handling a non-unicast packet is depicted. The method 1000 may be performed at a network device, such as one or more of the network devices of FIGS. 1-3. For example, the method 1000 may be performed by the network device 252 of FIG. 3.

The method 1000 includes obtaining, at a first network device, routing tree information descriptive of a loop-free routing path for non-unicast communications via a mesh network, at 1002. For example, the network device 252 may determine the routing tree information based on a spanning tree of the mesh network. Alternately, the network device 252 may receive the routing tree information from another network device.

The method 1000 also includes storing, at a memory of the first network device, routing data based on the routing tree information. For example, the routing data may be stored as a routing table entry in a routing table. The routing data identifies one or more non-unicast path neighbor devices of the first network device. As explained further below, non-unicast packets received by the first network device from the one or more non-unicast path neighbor devices are to be routed according to the loop-free routing path.

The method 1000 includes receiving, at the first network device, a non-unicast packet from a particular network device, at 1006. For example, the network device 252 of FIG. 3 may receive a non-unicast packet (e.g., a broadcast packet or a multicast packet) from one of its neighboring network devices (e.g., the network device 104, the network device 250, the network device 254, the network device 258, or the network device 260).

The method also includes, at 1008, accessing the routing data stored in the memory of the first network device. The routing data may identify one or more non-unicast path neighbor devices among the network devices.

The method 1000 further includes, at 1010, determining, based on the routing data, whether the particular network device (from which the non-unicast packet was received) is a non-unicast path neighbor device of the first network device. A “non-unicast path neighbor device” of the first network device is a device that is “connected” to the first network device in the spanning tree of FIG. 3 and that is recognized as an authorized sender or recipient of non-unicast messages, such as broadcast messages or multicast messages. It should be understood that a network device may be both a “unicast path neighbor device” and a “non-unicast path neighbor device.” To illustrate, the unicast path neighbor devices of the network device 252 illustrated in FIG. 2 are the network device 104, the network device 250, the network device 254, the network device 258, and the network device 260. The network device 104, the network device 250, the network device 254, and the network device 258 are also non-unicast path neighbor devices of the network device 252 and may be identified in the non-unicast packet routing neighbor device list of FIG. 4. In contrast, the network device 260 is a unicast path neighbor device of the network device 252 but is not a non-unicast path neighbor device of the network device 252.

The method 1000 includes, in response to determining that the particular network device is a non-unicast path neighbor device, at 1012, sending (e.g., forwarding) the non-unicast packet as a broadcast packet or multicast packet, at 1014. In response to determining, at 1012, that the particular network device is not a non-unicast path neighbor device, the method 1000 includes dropping the non-unicast packet, at 1016.

By selectively transmitting non-unicast packets received from a neighbor in the routing tree (the loop-free routing path) to other neighbors in the routing tree and by dropping non-unicasts packets received from devices that are not neighbors in the routing tree, broadcast and multicast packets may be routed to all network devices with improved overall network efficiency. For example, transmission loops between multiple devices in the network may be avoided, reducing overall link usage and conserving network transmission resources.

In conjunction with the described techniques, an apparatus includes means for receiving, at a first network device from one or more other network devices, first control message data units (CMDUs) including network information descriptive of links between network devices of a network. For example, the means for receiving the first CMDUs may include or correspond to the processor 120 of FIG. 1. In this example, the processor 120 is configured to execute instructions to implement an IEEE 1905.1 compliant protocol stack that is extended to generate the one or more CMDUs including the routing path information. For example, the protocol stack 142 may generate the one or more CMDUs at an abstraction layer between a physical layer and a network layer of the protocol stack.

As another example, the means for receiving the first CMDUs includes or corresponds to a portion of the network interface 140 of FIG. 1, the wireless communication circuitry 146, the wired communication circuitry 148, one or more other devices, circuits, modules, or any combination thereof. In a particular example, the means for receiving the first CMDUs may include the processor 120 executing instructions to implement the protocol stack, or a portion of the protocol stack that implements an extended IEEE 1905.1 specification.

The apparatus may also include means for determining, based on the network information, an end-to-end routing path for unicast communications from the first network device to a third network device of the network, where the end-to-end routing path traverses a second network device of the network. For example, the means for determining the end-to-end routing path may include or correspond to the processor 120, the network interface 140 of FIG. 1, the wireless communication circuitry 146, the wired communication circuitry 148, one or more other devices, circuits, modules, or any combination thereof.

The apparatus may also include means for sending, from the first network device to the second network device, one or more second CMDUs including routing path information descriptive of at least a portion of the end-to-end routing path, where the routing path information is configured to cause the second network device to forward, along the portion of the end-to-end routing path, unicast packets received from the first network device and addressed to the third network device. For example, the means for sending the one or more second CMDUs may include or correspond to the processor 120, the network interface 140 of FIG. 1, the wireless communication circuitry 146, the wired communication circuitry 148, one or more other devices, circuits, modules, or any combination thereof.

In some implementations, the apparatus may also include means for detecting link characteristics of links between the first network device and the one or more other neighbor devices of the network. For example, the means for detecting the link characteristics may include or correspond to the processor 120, the network interface 140, the wireless communication circuitry 146, the wired communication circuitry 148, one or more other devices, circuits, modules, or any combination thereof.

In some implementations, the apparatus includes means for sending, via one or more third CMDUs, link information, based on the link characteristics, to at least one of the one or more other neighbor devices. For example, the means for sending the one or more third CMDUs may include the processor 120, the network interface 140 of FIG. 1, the wireless communication circuitry 146, the wired communication circuitry 148, one or more other devices, circuits, modules, or any combination thereof.

In some implementations, the apparatus includes means for detecting expiration of a timer. In this implementation, the means for determining the end-to-end routing path configured to determine the end-to-end routing path responsive to expiration of the timer. For example, the means for detecting the expiration of the timer may include or correspond to the processor 120, one or more other devices, circuits, modules, or any combination thereof.

In some implementations, the apparatus includes means for storing a routing table entry. The routing table entry may be based on CMDUs received from another network device of the network. The routing table entry may identify a next hop device for unicast communications from the other network device to yet another network device of the network. For example, the means for storing the routing table entry may include or correspond to the processor 120, the memory 132, one or more other devices, circuits, modules, or any combination thereof.

In some implementations, the apparatus includes means for sending (e.g., forwarding) a unicast packet to a next hop device based on a routing table entry and based on the unicast packet identifying an originating device and a destination device. For example, the means for sending the unicast packet may include the processor 120, the network interface 140 of FIG. 1, the wireless communication circuitry 146, the wired communication circuitry 148, one or more other devices, circuits, modules, or any combination thereof.

In some implementations, the apparatus includes means for storing routing data based on routing tree information, where the routing tree information is descriptive of a loop-free routing path, via the network, for non-unicast packets. The routing data identifies one or more non-unicast path neighbor devices. For example, the means for storing the routing table entry may include or correspond to the processor 120, the memory 132, one or more other devices, circuits, modules, or any combination thereof.

In some implementations, the apparatus may include means for forwarding first non-unicast communications received from the one or more non-unicast path neighbor devices according to the loop-free routing paths, and for dropping second non-unicast communications received from devices other than the one or more non-unicast path neighbor devices. For example, the means for forwarding first non-unicast communications and for dropping second non-unicast communications may include the processor 120, the network interface 140 of FIG. 1, the wireless communication circuitry 146, the wired communication circuitry 148, one or more other devices, circuits, modules, or any combination thereof.

Those of skill in the art would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient (or non-transitory) computer readable storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed implementations is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims.

What is claimed is:

1. A networking apparatus comprising:
a communication circuitry configured to receive, via first control message data units (CMDUs), network information descriptive of links between network devices of a network; and
a processor configured to determine, based on the network information, an end-to-end routing path for unicast communications from the communication circuitry to a second network device of the network, the end-to-end routing path traversing a first network device of the network, the processor further configured to cause the communication circuitry to send, to the first network device via one or more second CMDUs, routing path information descriptive of at least a portion of the end-to-end routing path, the routing path information identifying a next hop network device along the portion of the end-to-end routing path to enable the first network device to forward, along the portion of the end-to-end routing path, unicast packets received from the communication circuitry and addressed to the second network device.

2. The networking apparatus of claim 1, wherein the network information indicates a link capacity of each of the links and indicates a link utilization of each of the links.

3. The networking apparatus of claim 1, wherein the processor is configured to determine the end-to-end routing path by:
determining a first end-to-end cost value associated with a first potential routing path, the first end-to-end cost value based on a respective link capacity of each link of the first potential routing path and based on a respective link utilization of each link of the first potential routing path;
determining a second end-to-end cost value associated with a second potential routing path, the second end-to-end cost value based on a respective link capacity of each link of the second potential routing path and based on a respective link utilization of each link of the second potential routing path; and
selecting the end-to-end routing path from the first potential routing path and the second potential routing path based on a comparison of the first end-to-end cost value and the second end-to-end cost value.

4. The networking apparatus of claim 1, further comprising a memory storing instructions to determine an uplink routing path, wherein the processor is configured to determine the end-to-end routing path by:
designating the second network device as an access point; and
executing the instructions to determine the uplink routing path to determine the end-to-end routing path.

5. The networking apparatus of claim 1, wherein the processor is further configured to detect a network configuration change of the network and to determine the end-to-end routing path responsive to detecting the network configuration change.

6. The networking apparatus of claim 1, further comprising a memory configured to store a routing table including a routing table entry, the routing table entry based on second routing path information received from a third network device, the second routing path information descriptive of a second end-to-end routing path for second unicast communications from the third network device to a fourth network device of the network, wherein the routing table entry indicates that the second unicast communications from the third network device to the fourth network device are to be routed according to the second end-to-end routing path.

7. The networking apparatus of claim 6, wherein the processor is further configured to, responsive to the communication circuitry receiving a unicast packet identifying the third network device as an originating device and identifying the fourth network device as a destination device, cause the communication circuitry to forward the unicast packet to a next hop device indicated in the routing table entry.

8. The networking apparatus of claim 1, wherein the processor is further configured to, responsive to an application executing at the processor generating a unicast packet for the second network device, cause the communication circuitry to transmit the unicast packet to the first network device, wherein the unicast packet includes an address associated with the communication circuitry as an originating device and identifies the second network device as a destination device, and wherein the unicast packet does not specify a routing path between the communication circuitry and the second network device.

9. A method of communicating via a network, the method comprising:
receiving, at a first network device from one or more other network devices, first control message data units (CMDUs) including network information descriptive of links between network devices of a network;
determining, based on the network information, an end-to-end routing path for unicast communications from the first network device to a third network device of the network, the end-to-end routing path traversing a second network device of the network; and
sending, from the first network device to the second network device, one or more second CMDUs including routing path information descriptive of at least a portion of the end-to-end routing path, the routing path information configured to cause the second network device to forward, along the portion of the end-to-end routing path, unicast packets received from the first network device and addressed to the third network device.

10. The method of claim 9, wherein determining the end-to-end routing path comprises:
determining, based on link capacities and link utilization of the links, a set of end-to-end cost values, each end-to-end cost value of the set associated with a respective potential end-to-end routing path from the first network device to the third network device via the network; and
selecting, as the end-to-end routing path, a potential end-to-end routing path associated with a lowest end-to-end cost value of the set.

11. The method of claim 9, wherein determining the end-to-end routing path comprises:
designating the third network device as an access point;
executing, at the first network device, uplink routing path instructions to determine an uplink routing path to the access point; and
designating the uplink routing path determined by the uplink routing path instructions as the end-to-end routing path.

12. The method of claim 9, further comprising:
determining link information descriptive of links between the first network device and the one or more other network devices of the network; and
sending, via one or more third CMDUs, the link information to the one or more other network devices.

13. The method of claim 9, further comprising:
determining, based on the network information, a second end-to-end routing path for second unicast communications from the first network device to a fourth network device of the network, the second end-to-end routing path traversing the second network device; and
sending, from the first network device to the second network device, one or more third CMDUs including second routing path information descriptive of at least a portion of the second end-to-end routing path, the second routing path information configured to cause the second network device to forward, along the portion of the second end-to-end routing path, second unicast packets received from the first network device and addressed to the fourth network device.

14. The method of claim 9, wherein the determining the end-to-end routing path is performed responsive to detecting that a device joined the network, responsive to detecting that a device left the network, or responsive to expiration of a timer.

15. The method of claim 9, further comprising:
receiving, at the first network device, third CMDUs including second routing path information descriptive of at least a portion of a second end-to-end routing path for second unicast communications from a fourth network device of the network to a fifth network device of the network;
storing, at a memory of the first network device, a routing table entry based on the second routing path information, the routing table entry identifying a next hop device of the second end-to-end routing path; and
responsive to receiving a unicast packet identifying the fourth network device as an originating device and identifying the fifth network device as a destination device, sending the unicast packet to the next hop device based on the routing table entry.

16. The method of claim 9, further comprising:
generating, at the first network device, a unicast packet for the third network device; and
sending the unicast packet to the second network device, wherein the unicast packet identifies the first network device as an originating device and identifies the third network device as a destination device, and wherein the unicast packet does not specify a routing path between the first network device and the third network device.

17. The method of claim 9, further comprising:
obtaining, at the first network device, routing tree information descriptive of a loop-free routing path for non-unicast communications via the network; and
storing, at a memory of the first network device, routing data based on the routing tree information, the routing data identifying one or more non-unicast path neighbor devices of the first network device, wherein non-unicast packets received by the first network device from the one or more non-unicast path neighbor devices are to be routed according to the loop-free routing path.

18. The method of claim 17, further comprising, after storing the routing data:
receiving, at the first network device, a non-unicast packet from a particular network device;
determining, based on the routing data, whether the particular network device is a non-unicast path neighbor device; and
in response to determining that the particular network device is a non-unicast path neighbor device, sending the non-unicast packet as a broadcast packet or as a multicast packet.

19. The method of claim 17, further comprising:
receiving, at the first network device, a non-unicast packet from a particular network device;
determining, based on the routing data, whether the particular network device is a non-unicast path neighbor device; and
in response to determining that the particular network device is not a non-unicast path neighbor device, dropping the non-unicast packet.

20. A networking apparatus comprising:
means for receiving, at a first network device from one or more other network devices, first control message data units (CMDUs) including network information descriptive of links between network devices of a network;
means for determining, based on the network information, an end-to-end routing path for unicast communications from the first network device to a third network device of the network, the end-to-end routing path traversing a second network device of the network; and
means for sending, from the first network device to the second network device, one or more second CMDUs including routing path information descriptive of at least a portion of the end-to-end routing path, the routing path information configured to cause the second network device to forward, along the portion of the end-to-end routing path, unicast packets received from the first network device and addressed to the third network device.

21. The networking apparatus of claim 20, further comprising:
means for detecting link characteristics of links between the first network device and the one or more other network devices of the network; and
means for sending, via one or more third CMDUs, link information, based on the link characteristics, to at least one of the one or more other network devices.

22. The networking apparatus of claim 20, further comprising means for storing uplink routing path instructions, the means for determining the end-to-end routing path configured to determine the end-to-end routing path by:
designating the third network device as an access point;
executing the uplink routing path instructions to determine an uplink routing path to the access point; and
designate the uplink routing path as the end-to-end routing path.

23. The networking apparatus of claim 20, further comprising means for detecting expiration of a timer, the means for determining the end-to-end routing path configured to determine the end-to-end routing path responsive to expiration of the timer.

24. The networking apparatus of claim 23, wherein the timer tracks an interval since detection of a heart beat signal from a device of the network.

25. The networking apparatus of claim 23, wherein the timer tracks an interval since a prior end-to-end routing path was determined.

26. The networking apparatus of claim 20, further comprising:
means for storing a routing table entry based on third CMDUs from a fourth network device of the network, the routing table entry identifying a next hop device for second unicast communications from the fourth network device to a fifth network device of the network; and
means for sending a unicast packet to the next hop device based on the routing table entry and based on the unicast packet identifying the fourth network device as an originating device and identifying the fifth network device as a destination device.

27. The networking apparatus of claim 20, further comprising:
means for storing routing data based on routing tree information, the routing tree information descriptive of a loop-free routing path, via the network, for non-unicast packets, the routing data identifying one or more non-unicast path neighbor devices; and
means for forwarding first non-unicast communications received from the one or more non-unicast path neighbor devices according to the loop-free routing paths, and for dropping first non-unicast communications received from devices other than the one or more non-unicast path neighbor devices.

28. A non-transitory computer readable medium storing instructions executable by a processor to cause the processor to perform operations comprising:
obtaining network information descriptive of links between network devices of a network;
determining, based on the network information, an end-to-end routing path for unicast communications from a first network device to a third network device of the network, the end-to-end routing path traversing a second network device of the network; and
causing a communication circuitry to send one or more control message data units (CMDUs) including routing path information descriptive of at least a portion of the end-to-end routing path, the routing path information configured to cause the second network device to forward, along the portion of the end-to-end routing path, unicast packets received from the communication circuitry and addressed to the third network device.

29. The non-transitory computer readable medium of claim 28, wherein the instructions include Institute of Electrical and Electronics Engineers (IEEE) 1905.1 compliant protocol stack instructions extended to generate the one or more CMDUs including the routing path information.

30. The non-transitory computer readable medium of claim 28, wherein the IEEE 1905.1 compliant protocol stack instructions are executable to generate the one or more CMDUs at an abstraction layer between a physical layer and a network layer.
